(19) United States
(12) Patent Application Publication
(10) Pub. No.: US 2022/0133575 A1
(43) Pub. Date: May 5, 2022

(54) Exercise Machine Providing Back-and Forth Movement and Vibration

(71) Applicant: Chung-Fu Chang, CHANGHUA HSIEN (TW)

(72) Inventor: Chung-Fu Chang, CHANGHUA HSIEN (TW)

(21) Appl. No.: 17/084,642

(22) Filed: Oct. 30, 2020

(51) Int. Cl. A61H 1/00; A63B 21/00; A61H 23/02

(52) U.S. Cl. CPC A61H 1/005; A63B 21/00196; A61H 2203/0406; A61H 2201/0165; A61H 23/0254

(57) ABSTRACT

An exercise machine which provides back-and-forth movement and vibration is revealed. The exercise machine includes a base and a loading platform in which two sides of a middle portion thereof are pivotally connected to the base. A motor, a first transmission device, and a second transmission device are mounted in the base. The motor drives the first transmission device which further drives the second transmission device. The second transmission device which is connected to the loading platform drives the loading platform to move back and forth while the first transmission device makes the base to have vibration. Thereby the exercise machine generates vibration and back-and-forth movement, allowing users to experience both motions.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to an exercise machine, especially to a passive exercise machine which allows users to exercise their whole body by vibration and back-and-forth movement.

### Description of Related Arts

The vibration fitness machine available now such as a massager for producing rotary and/or vibratory massage motion revealed in U.S. Pat. No. 5,797,859 uses motors to generate the massage motion. A gear structure couples the motor to the at least one rotator structure to cause rotary movement thereof, upon actuation of the motor. The massager includes an eccentric weight and a clutch system for driveably coupling the eccentric weight to the motor when the motor produces a first direction rotary output. In such manner, the single motor operates both the rotator structure and the eccentric weight and enables combines rotary/vibratory motion to be achieved.

However, the above technique which uses motor to drive the gears and further operate the eccentric weight for generating vibration only provides the exercise machine one type of vibration. Moreover, not only unsmooth movement but also a lot of noises are generated during the gear transmission process.

### SUMMARY OF THE PRESENT INVENTION

Therefore it is a primary object of the present invention to provide an exercise machine which is composed of a motor, two transmission devices and a plurality of belts used for driving the transmission devices for allowing users to experience both vibration and back-and-forth movement in a seesaw manner.

In order to achieve the above object, an exercise machine which provides back-and-forth movement and vibration according to the present invention includes a base and a loading platform which is pivotally connected to the base and adapted for users to stand thereon. Muscle contraction in the users' bodies is affected by vibration and back-and-forth movement with different amplitudes generated by the exercise machine and such vibration and movement provided complements or mimics the neuro-muscular response we have during a walk.

As the rhythmic vibration and the back-and-forth movement of the loading platform reach the legs and the top of the body, all pelvic and core muscles of the torso are activated and this helps user's body get oxygen. The muscles are also passively vibrated. Thereby a better workout for the muscles is obtained.

Besides the base and the loading platform, the exercise machine further includes a motor, a first transmission device, and a second transmission device all mounted in the base. The motor is connected to the first transmission device by a first belt and the first transmission device is connected to the second transmission device by a second belt while the second transmission device is connected to the loading platform. A first pivot part and a second pivot part arranged at two sides of a middle portion of the frame body respectively. The first pivot part and the second pivot part are pivotally connected to two sides of a middle portion of the base respectively. The second transmission device is connected to the loading platform for driving the loading platform to move back and forth like a seesaw. The motor is disposed on the first side portion of the base while the first transmission device is arranged at a middle portion of the base and a second transmission device is mounted on the second side portion of the base. The motor drives both the first and the second transmission devices to rotate simultaneously. The first transmission device is driven to generate vibration while the second transmission is driven to generate back-and-forth movement. Thereby the exercise machine allows users to experience both the vibration and the back-and-forth movement.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a schematic drawing showing a base and a loading platform separated from each other of an embodiment according to the present invention;

FIG. 2 is a perspective view of an embodiment according to the present invention;

FIG. 3 is a top view of an embodiment according to the present invention;

FIG. 4 is a side view of an embodiment according to the present invention.

### DETAILED DESCRIPTION OF THE PREFERRED EMBODIMENT

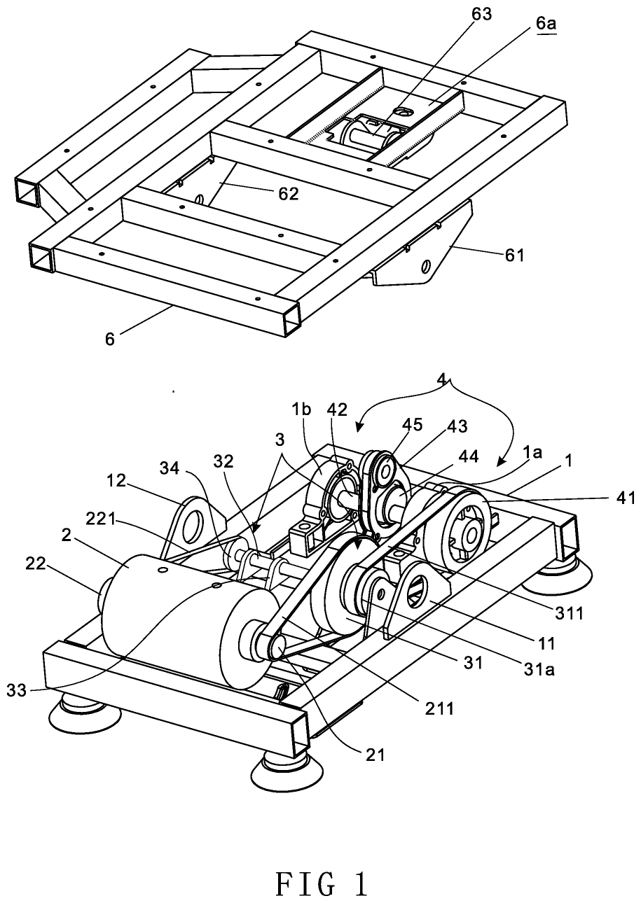

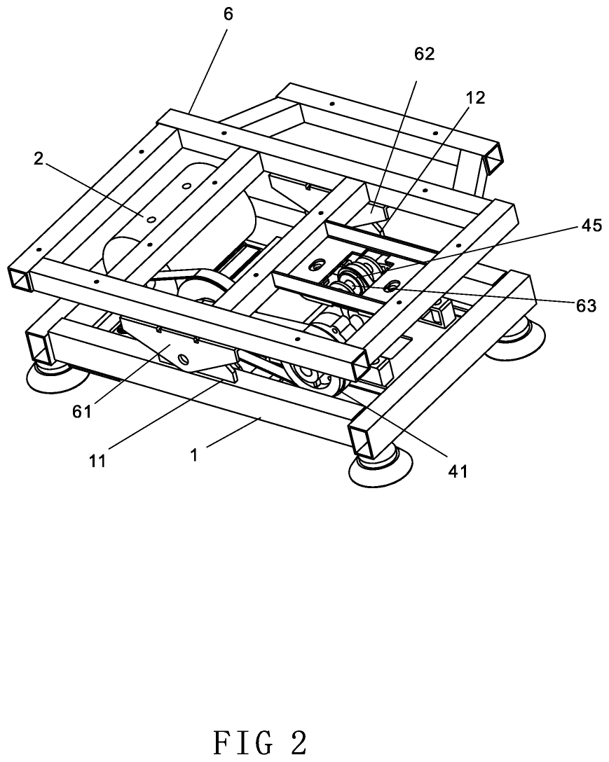

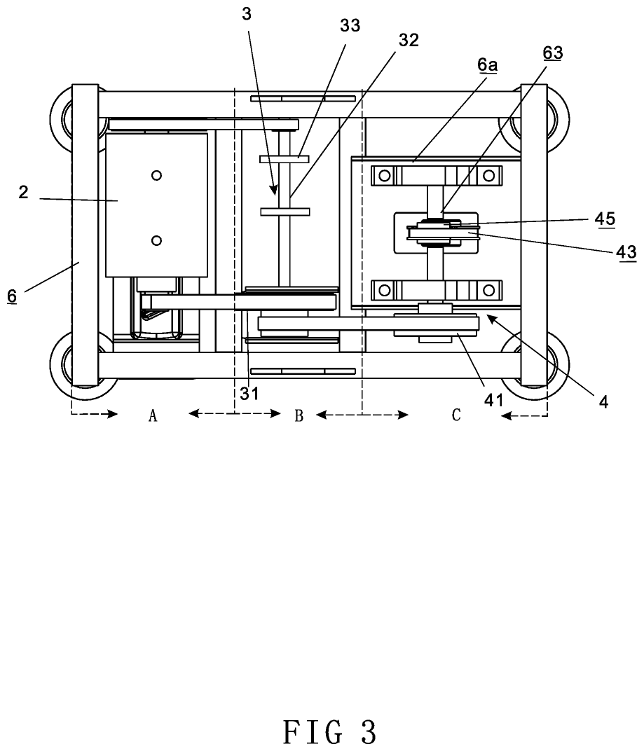

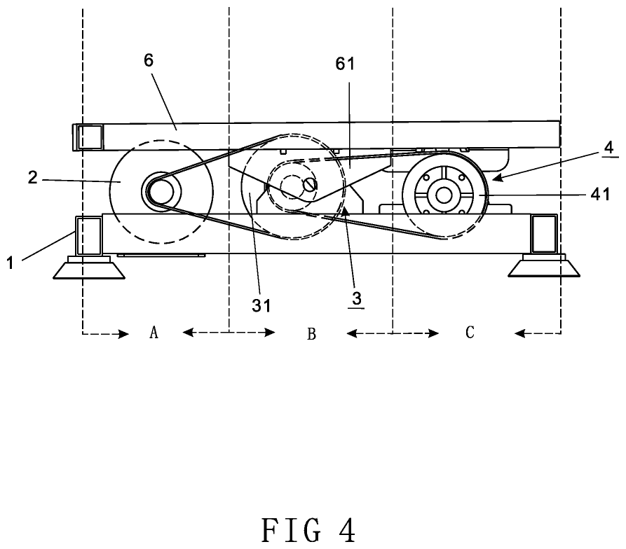

Referring to FIG. 1-4, an exercise machine according to the present invention includes a base 1 which is a frame body, a motor 2, a first transmission device 3, a second transmission device 4, and a loading platform 6. The motor 2, the first transmission device 3, and the second transmission device 4 are mounted in the frame body of the base 1. The motor 2 is adapted for driving the first transmission device 3 and the second transmission device 4. As shown in FIG. 3 and FIG. 4, the frame body of the base 1 is divided into a first side portion A, a middle portion B and a second side portion C. The motor 2 is disposed on the first side portion A of the base 1 while the first transmission device 3 is arranged at about the middle portion B of the base 1. A pair of bearings 1a, 1b are disposed on the second side portion C of the base 1 and used for mounting the second transmission device 4. A first support 11 and a second support 12 are formed on two sides of the middle portion B of the base 1 respectively. The loading platform 6 is also a frame body composed of an assembly base 6a, a first pivot part 61 and a second pivot part 62. The first pivot part 61 and the second pivot part 62 are arranged at two sides of a middle portion of the frame body respectively and opposite to each other. By the first pivot part 61 and the second pivot part 62 connected with the first support 11 and the second support 12 correspondingly, the loading platform 6 is able to be moved back and forth in a seesaw manner. The loading platform 6 further includes a shaft 63 pivotally connected to the assembly base 6a.

The first transmission device 3 consists of a first turning wheel 31, a first axial rod 32, at least one first eccentric wheel 33, and a third turning wheel 34. Two ends of the first axial rod 32 are arranged at two sides of the middle portion B of the base 1 respectively. The first turning wheel 31, the first eccentric wheel 33, and the third turning wheel 34 are in turn disposed on the first axial rod 32. As to the second transmission device 4, it includes a second turning wheel 41, a second axial rod 42, a connecting part 43, and a second eccentric wheel 44, and a bearing 45. The second axial rod 42 is pivotally connected to the bearings 1a, 1b while the second turning wheel 41 is mounted on one end thereof and the other end thereof is inserted through the bearing 1a and provided with the second eccentric wheel 44. The second eccentric wheel 44 is enclosed in the connecting part 43 while the baring 45 is arranged at the connecting part 43 and located over the second eccentric wheel 44. The baring 45 is further pivotally connected to the shaft 63 of the loading platform 6. A first belt 211 is passed around both the first wheel shaft 21 of the motor 2 and the first turning wheel 31 for connecting the first wheel shaft 21 with the first turning wheel 31. A second belt 311 is passed around not only the third wheel shaft 31a of the first turning wheel 31 but also the second turning wheel 41 for connecting the first turning wheel 31 and the second turning wheel 41. The first axial rod 32 is not only axially connected with the first turning wheel 31 and the at least one first eccentric wheel 33 but also pivotally disposed on the two sides of the middle portion B of the base 1. A distal end of the first axial rod 32 is provided with the third turning wheel 34. The second axial rod 42 is axially connected with the second turning wheel 41 and the second eccentric wheel 44. A second wheel shaft 22 is extending from the other end of the motor 2, opposite to the end with the wheel shaft 21. A third belt 221 is passed around the second wheel shaft 22 and the third turning wheel 34 for connecting the second wheel shaft 22 and the third turning wheel 34. Thereby the first wheel shaft 21 drives the first turning wheel 31 to rotate by the first belt 211 when the motor 2 starts to rotate. While the first turning wheel 31 is rotating, the third wheel shaft 31a of the first turning wheel 31 drives the second turning wheel 41 to rotate by the second belt 311. During rotation of the second turning wheel 41, the second axial rod 42 thereof drives the second eccentric wheel 44 to move. Owing to eccentricity of the second eccentric wheel 44, the connecting part 43 is driven to move up and down so that the bearing 45 on an upper part of the connecting part 43 is moved to abut against the assembly base 6a on one side of the loading platform 6 and further drive the loading platform 6 to move back and forth with reciprocating vertical displacements on the first support 11 and the second support 12 (used as fulcrums) of the base 1 at one side of the base 1 like a seesaw. Synchronously the first turning wheel 31 and the third turning wheel 34 drive the first eccentric wheel 33 to rotate and generate a deflection force which is transmitted to the base 1 for creating vibration. In a word, the motor 2 drives both the first transmission device 3 and the second transmission device 4 at the same time so as to have vibration and back-and forth movement. Thereby the exercise machine allows users to experience both vibration and back-and-forth movement.

One of the first turning wheel 31, the third turning wheel 34, the second wheel shaft 22, and the second turning wheel 41 can be provided with a one-way bearing. Thereby users can select one of the wheels 22, 31, 34, 41 as the wheel being driven to rotate when the motor 2 is rotated in a selected direction such as the clockwise direction or the counterclockwise direction.

Moreover, the third turning wheel 34 can also be an eccentric wheel for replacement of the second eccentric wheel 44.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. An exercise machine which provides back-and-forth movement and vibration comprising:
a base which is a frame body divided into divided into a first side portion, a second side portion, and a middle portion in which two sides thereof are provided with a first support and a second support respectively;
a loading platform adapted for users to stand thereon and provided with a shaft disposed close to one side thereof;
a motor disposed on the first side portion of the base;
a first transmission device which is arranged at about the middle portion of the base and having a first axial rod, a first turning wheel disposed on one end of the first axial rod, and at least one first eccentric wheel arranged at the other end or a middle portion of the first axial rod; the motor being connected to the first turning wheel by a first belt; and
a second transmission device which is disposed on the second side portion of the base and including a second axial rod, a second turning wheel mounted on one end of the second axial rod, a second eccentric wheel arranged close to a middle portion of the second axial rod and enclosed in the connecting part, and a baring mounted on the connecting part and pivotally connected to the shaft of the loading platform; the first turning wheel being connected to the second turning wheel by a second belt;
wherein a first pivot part and a second pivot part arranged at two sides of a middle portion of the frame body respectively, located opposite to each other, and pivotally connected to two sides of the middle portion of the base respectively; thereby while the second eccentric wheel is rotated, the loading platform is synchronously driven to move back and forth with reciprocating vertical displacement on the first support and the second support of the base at one side of the base like a seesaw owing to the baring connected to the shaft;
wherein the motor drives the first transmission device to generate vibration; the motor simultaneously drives the second transmission device to make the loading platform to have back-and-forth movement; the first transmission device makes the base generate vibration which are delivered to users; the back-and-forth movement of the loading platform driven by the second transmission device are transmitted to users' feet and further torsos.

2. The exercise machine as claimed in claim 1, wherein a second wheel shaft is extending from the other end of the motor, opposite to the end with the wheel shaft; a third turning wheel is disposed on a distal end of the first axial rod; a third belt is passed around the second wheel shaft and the third turning wheel for connecting the second wheel shaft and the third turning wheel.

3. The exercise machine as claimed in claim 1, wherein one of the first turning wheel, the second wheel shaft, and the second turning wheel is provided with a one-way bearing; thereby one of the first turning wheel, the second wheel shaft, and the second turning wheel is able to be selected for being driven to rotate when the motor is rotated in a selected direction.

4. The exercise machine as claimed in claim 1, wherein the third turning wheel is able to be an eccentric wheel for replacement of the second eccentric wheel.

5. The exercise machine as claimed in claim 2, wherein the third turning wheel is provided with a one-way bearing so that whether the third turning wheel is driven to rotate or not is able to be selected when the motor is rotated in a selected direction.
